(19) United States
(12) Patent Application Publication
(10) Pub. No.: US 2023/0364964 A1
(43) Pub. Date: Nov. 16, 2023

(54) SET OF COOLING MODULES WITH TANGENTIAL TURBOMACHINES, FOR THE FRONT FACE OF AN ELECTRIC OR HYBRID MOTOR VEHICLE

(71) Applicant: Valeo Systemes Thermiques, Le Mesnil Saint-Denis (FR)

(72) Inventors: Amrid Mammeri, Le Mesnil Saint Denis Cedex (FR); Kamel Azzouz, Le Mesnil Saint Denis Cedex (FR); Gael Durbecq, Le Mesnil Saint Denis Cedex (FR); Erwan Etienne, Le Mesnil Saint Denis Cedex (FR)

(73) Assignee: Valeo Systemes Thermiques, Le Mesnil Saint-Denis (FR)

(21) Appl. No.: 18/026,226

(22) PCT Filed: Sep. 8, 2021
(86) PCT No.: PCT/EP2021/074686

§ 371 Date: Mar. 14, 2023

(30) Foreign Application Priority Data
Sep. 15, 2020 (FR) 2009353

(51) Int. Cl. B60H 1/00

(52) U.S. Cl. CPC B60H 1/00278; B60H 1/00385; H01M 10/625

(57) ABSTRACT

The present invention relates to a set of cooling modules (22, 22′, 22″) for the front face of an electric or hybrid motor vehicle (10), said set of cooling modules (22, 22′, 22″) comprising at least two cooling modules (22, 22′, 22″) each one comprising—a heat exchanger (28, 28′, 28″) intended to be connected to a cooling circuit, and—a turbomachine (30, 30′, 30″), said cooling modules (22, 22′, 22″) being juxtaposed in such a way as to have distinct air flows (F) passing through them.

The present invention relates to a set of cooling modules with tangential-flow turbomachines, for the front face of an electric or hybrid motor vehicle.

A cooling module (or heat exchange module) of a motor vehicle conventionally comprises at least one heat exchanger and a ventilation device which is designed to generate a flow of air in contact with the at least one heat exchanger. The ventilation device thus makes it possible, for example, to generate an airflow in contact with the heat exchanger, when the vehicle is stationary or running at low speed.

In motor vehicles with a conventional combustion engine, the at least one heat exchanger has a substantially square or rectangular shape, with the ventilation device then being a blower-wheel fan, the diameter of which is substantially equal to the side of the square formed by the heat exchanger.

Conventionally, the heat exchanger is then placed facing at least two cooling openings, formed in the front face of the body of the motor vehicle. A first cooling opening is located above the bumper, while a second opening is located below the bumper. Such a configuration is preferred since the combustion engine must also be supplied with air, the air intake of the engine conventionally being located in the passage of the airflow passing through the upper cooling opening.

However, electric vehicles are preferably provided solely with cooling openings located below the bumper, and more preferably still with a single cooling opening located below the bumper. This is because the electric motor does not need to be supplied with air. The reduction in the number of cooling openings also makes it possible to improve the aerodynamic characteristics of the electric vehicle. This also results in better range and a higher top speed of the motor vehicle.

This reduction in the number of cooling openings also leads to a reduction in the amount of surface area available for the passage of an airflow passing through the heat exchangers positioned downstream. The demand for cooling power differs depending on usage, for example for cooling the batteries in normal use or else during charging, for example rapid charging. During rapid charging of the batteries, the demand for cooling power is high and it is therefore necessary to have a large surface area for heat exchange. During normal use of the batteries, the demand for cooling power is lower and therefore a smaller surface area for heat exchange may be adequate.

The rapid charging of the batteries is performed with the vehicle stationary. A large surface area for heat exchange at the cooling module and powerful ventilation means are therefore needed for suitable thermal management of the batteries. For normal use of the batteries during running, not all of this heat-exchange surface area is required for suitable thermal management of these batteries. That means that there is an excessive air intake in the front face which thus reduces the aerodynamic characteristics of the electric or hybrid vehicle, and this may reduce the range and top speed of the motor vehicle.

The aim of the present invention is therefore to at least partially overcome the disadvantages of the prior art and to propose an improved motor vehicle front face.

The present invention therefore relates to a set of cooling modules for the front face of an electric or hybrid motor vehicle, said set of cooling modules comprising at least two cooling modules each one comprising
a heat exchanger intended to be connected to a cooling circuit, and
a turbomachine,
   said cooling modules being juxtaposed in such a way as to have distinct airflows passing through them.

According to one aspect of the invention, the heat exchangers of the cooling modules are condensers connected to a refrigerant circulation loop configured for the thermal management of the batteries of the electric or hybrid vehicle.

According to another aspect of the invention, the heat exchangers of the cooling modules are connected in parallel with one another within the refrigerant circulation loop.

According to another aspect of the invention, the heat exchangers of the cooling modules are connected in series within the refrigerant circulation loop.

According to another aspect of the invention, each cooling module comprises an individual motor, configured to drive the rotation of the turbomachine thereof.

According to another aspect of the invention, the set of cooling modules comprises a common motor configured to drive the simultaneous rotation of the turbomachines of each cooling module.

According to another aspect of the invention, the turbomachines (30, 30′, 30″) of the juxtaposed cooling modules are connected to one another by a connecting and driving shaft.

According to another aspect of the invention, the connecting and driving shaft comprises an articulation.

According to another aspect of the invention, the cooling modules each comprise a dedicated shut-off device.

According to another aspect of the invention, the set of cooling modules comprises a main cooling module and at least one secondary cooling module smaller in size than the main cooling module.

The present invention also relates to a front face of an electric and/or hybrid motor vehicle comprising a set of cooling modules as described hereinabove.

Further features and advantages of the present invention will become more clearly apparent from reading the following description, which is given by way of nonlimiting illustration, and with reference to the accompanying drawings, in which:

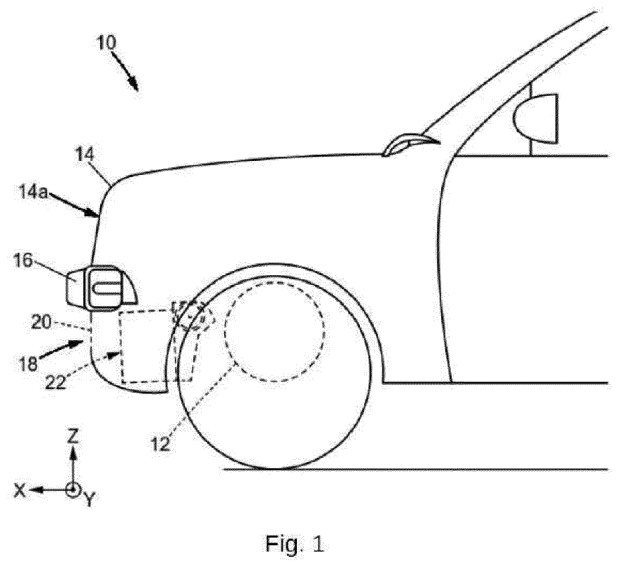

FIG. 1 shows a schematic depiction of the front of a motor vehicle in side view,

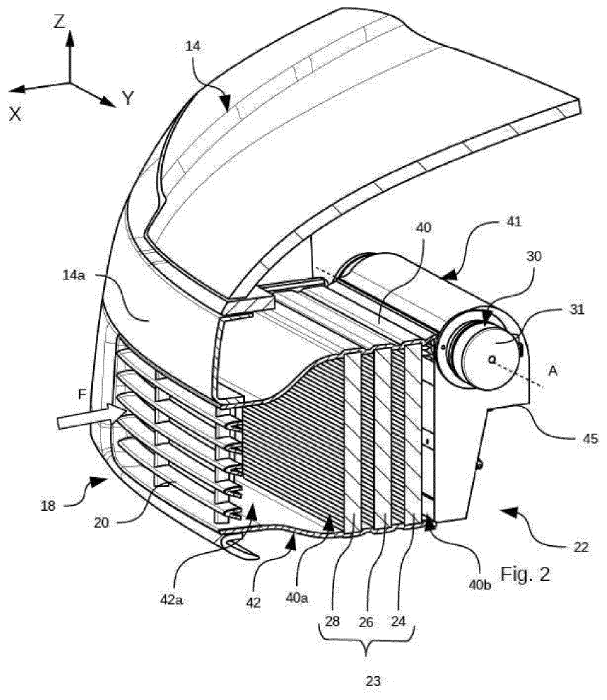

FIG. 2 shows a schematic perspective depiction in partial cross section of the front of a motor vehicle and of a cooling module,

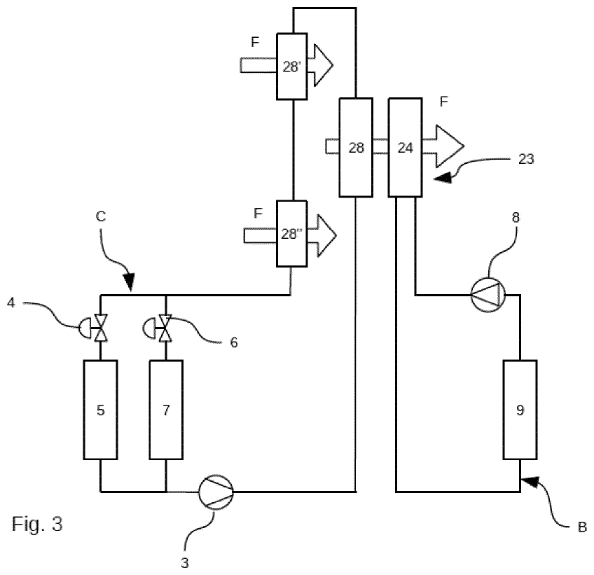

FIG. 3 shows a schematic depiction of a thermal management circuit according to a first embodiment,

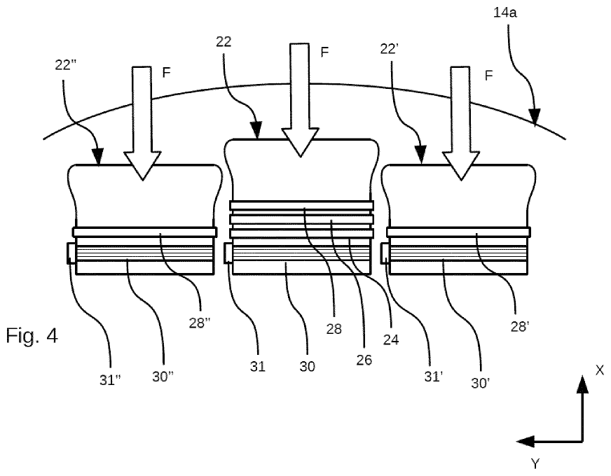

FIG. 4 shows a schematic depiction, viewed from above, of a set of cooling modules according to a first embodiment,

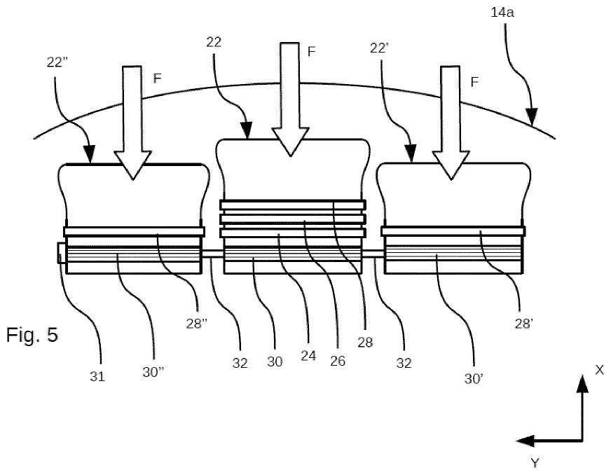

FIG. 5 shows a schematic depiction, viewed from above, of a set of cooling modules according to a second embodiment,

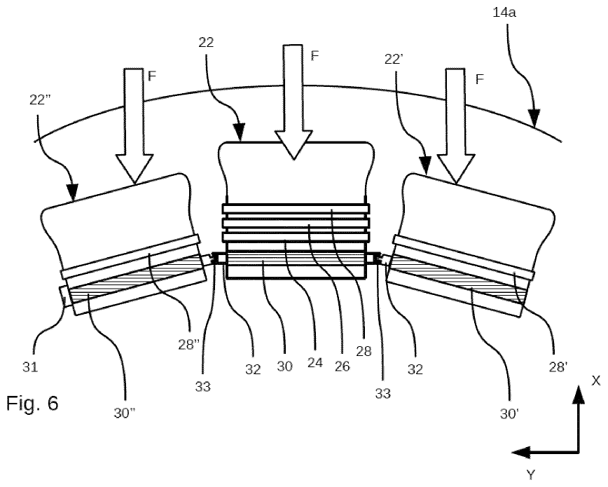

FIG. 6 shows a schematic depiction, viewed from above, of a set of cooling modules according to a third embodiment,

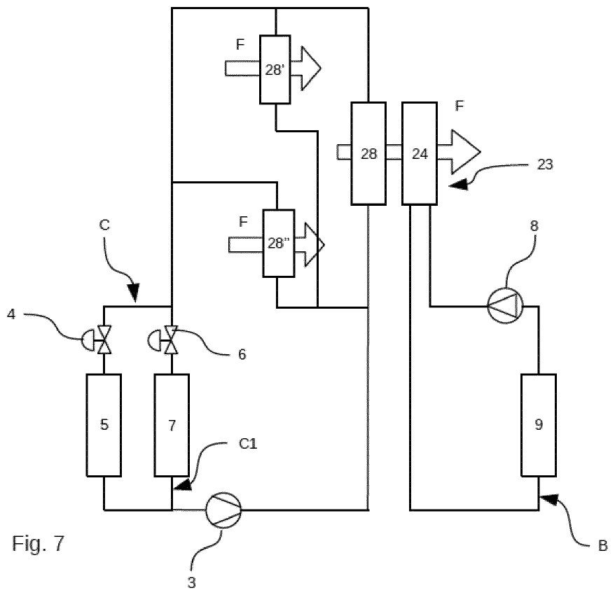

FIG. 7 shows a schematic depiction of a thermal management circuit according to a second embodiment.

The following embodiments are examples. Although the description refers to one or more embodiments, this does not necessarily mean that each reference relates to the same embodiment, or that the features apply only to one embodiment. Individual features of different embodiments may also be combined and/or interchanged to provide other embodiments.

In the present description, certain elements or parameters can be indexed, for example first element or second element and also first parameter and second parameter or first criterion and second criterion, etc. In this case, the index is used simply to differentiate between and denote elements or parameters or criteria that are similar but not identical.

This indexing does not imply priority being given to one element, parameter or criterion over another and such designation may be interchanged easily without departing from the scope of the present description. Neither does this indexing imply any chronological order for example in assessing any given criterion.

In the present description, “placed upstream” means that an element is placed before another relative to the direction of circulation of an airflow. By contrast, “placed downstream” means that an element is placed after another relative to the direction of circulation of the airflow.

In FIGS. 1 and 2, and 4 to 6, a trihedron XYZ is shown in order to define the orientation of the various elements relative to one another. A first direction, denoted X, corresponds to a longitudinal direction of the vehicle. It also corresponds to the direction of forward travel of the vehicle. A second direction, denoted Y, is a lateral or transverse direction. Finally, a third direction, denoted Z, is vertical. The directions X, Y, Z are orthogonal in pairs.

FIGS. 1 and 2 illustrate a main cooling module 22 in a functional position, which is to say when positioned within a motor vehicle, more specifically at the front face of said motor vehicle.

FIG. 1 illustrates schematically the front part of an electric or hybrid motor vehicle 10 which can comprise an electric motor 12. The vehicle 10 notably comprises a body 14 and a bumper 16 which are borne by a chassis (not shown) of the motor vehicle 10. The body 14 defines a cooling opening 18, that is, an opening through the body 14. In this case, there is only one cooling opening 18. This cooling opening 18 is preferably in the lower part of the front face 14a of the body 14. In the example illustrated, the cooling opening 18 is situated below the bumper 16. A grille 20 can be positioned in the cooling opening 18 to prevent projectiles from being able to pass through the cooling opening 18. At least two cooling modules 22, 22′, 22″ (only a main cooling module 22 is depicted in FIG. 1) are positioned facing the cooling opening 18.

More particularly, the front face of the electric or hybrid vehicle comprises a set of cooling modules 22, 22′, 22″ which are juxtaposed and visible in more detail in FIGS. 4 to 6. This set of cooling modules 22, 22′, 22″ comprises a main cooling module 22 and at least one secondary cooling module 22′, 22″. The grille 20 notably makes it possible to protect the various cooling modules 22, 22′, 22″.

As shown in FIG. 2, the main cooling module 22 is designed to have passing through it an airflow F parallel to the direction X, and going from the front to the rear of the vehicle 10. The main cooling module 22 comprises a set of heat exchangers 23 through which the airflow F passes.

The main cooling module 22 may essentially comprise a housing or fairing 40 forming an internal duct between two opposite ends 40a, 40b and inside which the set of heat exchangers 23 is disposed. This internal duct is preferably oriented parallel to the direction X such that the upstream end 40a is oriented toward the front of the vehicle 10, facing the cooling opening 18, and such that the downstream end 40b is oriented toward the rear of the vehicle 10.

The main cooling module 22 may also comprise a first collector housing 41 positioned downstream from the set of heat exchangers 23 in the direction of circulation of the airflow. This first collector housing 41 comprises an outlet 45 for the airflow F. This first collector housing 41 thus makes it possible to recover the airflow passing through the set of heat exchangers 23, and to orient this airflow toward the outlet 45. The first collector housing 41 can be integral with the fairing 40 or it can be an added-on part secured to the downstream end 40b of said fairing 40.

The main cooling module 22 also comprises at least one tangential-flow fan, also known as a tangential-flow turbomachine 30, which is configured such as to generate the airflow F destined for the set of heat exchangers 23. The tangential-flow turbomachine 30 comprises a rotor or turbine (or tangential blower-wheel). The turbine has a substantially cylindrical shape. The turbine advantageously comprises a plurality of stages of blades (or vanes). The turbine is mounted so as to be able to rotate about an axis of rotation A, which is for example parallel to the direction Y. The diameter of the turbine is for example between 35 mm and 200 mm so as to limit its size. The tangential-flow turbomachine 30 is thus compact. The use of such a tangential-flow turbomachine 30 notably makes it possible for the airflow F to be equal across the entire width of the set of heat exchangers 23. In addition, such a tangential-flow turbomachine 30 enables a space-saving in comparison with conventional fans.

The tangential-flow turbomachine 30 may also comprise a motor 31 (visible in FIG. 2) configured to set the turbine in rotation. The motor 31 is for example designed to drive the rotation of the turbine at a speed of between 200 rpm and 14 000 rpm. This notably makes it possible to limit the noise generated by the tangential-flow turbomachine 30.

The tangential-flow turbomachine 30 is preferably positioned in the first collector housing 41. The tangential-flow turbomachine 30 is then configured to draw in air so as to generate the airflow F passing through the set of heat exchangers 23. The first collector housing 41 then forms a blower housing volute at the center of which the turbine is positioned, and from which the evacuation of air at the outlet 45 of the first collector housing 41 allows the airflow F to exit.

In the example illustrated in FIG. 2, the tangential-flow turbomachine 30 is in a high position, notably in the upper third of the first collector housing 41, preferably in the upper quarter of the first collector housing 41. This notably makes it possible to protect the tangential-flow turbomachine in the event of submersion, and/or to limit the space taken up by the main cooling module 22 in its bottom part.

It is nevertheless conceivable for the tangential-flow turbomachine 30 to be in a low position, notably in the lower third of the first collector housing 41. This would make it possible to limit the space taken up by the main cooling module 22 in its upper part. Alternatively, the tangential-flow turbomachine 30 can be in a median position, in particular in the median third of the height of the first collector housing 41, for example for reasons of integration of the cooling module 22 into its surroundings.

In addition, in the example illustrated in FIG. 2, the tangential-flow turbomachine 30 operates by suction, i.e. it draws in the ambient air so that the air passes through all of the heat exchangers 23. Alternatively, the tangential-flow turbomachine 30 can operate by blowing, blowing the air toward the set of heat exchangers 23. For that purpose, the tangential-flow turbomachine 30 will be positioned upstream from the set of heat exchangers 23.

The main cooling module 22 can also comprise a second collector housing 42 positioned upstream from the set of heat exchangers 23. This second collector housing 42 comprises an inlet 42a for the airflow F coming from outside the vehicle 10. The inlet 42a can in particular be positioned facing the cooling opening 18. This inlet 42a can also comprise the protective grille 20. The second collector housing 42 can be integral with the fairing 40 or else be an added-on part secured to the upstream end 40a of said fairing 40.

In addition, the inlet 42a of the second collector housing 42 may have a front face shut-off device (not depicted) that is able to move between a first position, known as the open position, and a second position, known as the shut-off position. This front face shut-off device is in particular configured to allow the airflow F coming from outside the vehicle 10 to pass through said inlet 42a in its open position and to shut off said airflow inlet 42a in its shut-off position. The device for shutting off the front face can be in different forms, such as, for example, in the form of a plurality of flaps mounted such as to pivot between a position of opening and a position of closure. These flaps are preferably mounted parallel to the direction Y. However, it is entirely possible to imagine other configurations such as, for example, flaps mounted parallel to the direction Z. The flaps can be flaps of the flag type, but other types of flaps such as butterfly flaps are entirely conceivable.

In the example of a main cooling module 22 that is illustrated in FIG. 2, the set of heat exchangers 23 more particularly comprises a plurality of heat exchangers 24, 26, 28 which are positioned one after another so that the one same airflow F passes through them. The main cooling module 22 here comprises three heat exchangers 24, 26 and 28. Each one of the heat exchangers may be dedicated to the removal of heat so as to cool elements or components within the electric vehicle.

The set of heat exchangers 23 of the main cooling module 22 notably comprises a heat exchanger 28 connected to a cooling circuit. More specifically, this heat exchanger 28 may be a condenser and may be connected to a refrigerant circulation loop C configured to enable thermal management of the batteries of the motor vehicle.

As shown in FIG. 3, the refrigerant circulation loop C may comprise, in the direction of circulation of the refrigerant, a compressor 3, the condenser 28, a first expansion device 4 and a heat-exchange interface 5 exchanging heat with the batteries. This heat exchange interface 5 may be in direct contact with the batteries or else may allow exchanges of heat energy with another circulation loop (not depicted) for indirect battery-temperature management. The refrigerant circulation loop C may for example be an air conditioning loop and comprise, in parallel with the first expansion device 4 and the heat-exchange interface 5, a second expansion device 6 and an evaporator 7 that is configured to cool an airflow intended for the vehicle interior. Other, more complex, architectures may of course be envisioned for this refrigerant circulation loop C.

As illustrated in FIG. 2, the set of heat exchangers 23 of the main cooling module 22 may comprise additional heat exchangers 24, 26. In the example illustrated, the main cooling module 22 comprises two additional heat exchangers 24 and 26. However, it is entirely possible to conceive of examples having just one additional heat exchanger 24. These additional heat exchangers 24, 26 may also be heat exchangers dedicated to the removal of heat so as to cool elements or components within the electric vehicle.

As illustrated in FIG. 3, one of these additional heat exchangers 24 may be a radiator connected to a heat-transfer fluid circulation loop B. This heat-transfer fluid circulation loop B may notably be configured to provide thermal management of electrical elements such as the power electronics and/or the electric motor of the motor vehicle. This heat-transfer fluid circulation loop B may thus comprise, in addition to the radiator 24, a pump 8 and a heat-exchange interface 9 exchanging heat with electrical elements such as the power electronics and/or the electric motor of the motor vehicle.

As shown in FIGS. 2 and 3, this radiator 24 is more particularly positioned the furthest downstream of the airflow F within the cooling module 22, notably downstream of the condenser 28. Specifically, since this radiator 24 provides thermal management for electrical elements such as the power electronics and/or the electric motor of the motor vehicle, the demand for cooling is lower than it is for other elements such as the batteries. The airflow F passing through the radiator 24 therefore does not need to be as “cool” as possible, unlike the airflow F passing through the condenser 28.

In the example illustrated in FIG. 3, the set of heat exchangers 23 comprises just two heat exchangers 28 and 24. The third heat exchanger 26 has not been depicted. The latter may be optional and for example connected to a heat-transfer fluid loop dedicated to the cooling of the electric motor.

As shown in FIGS. 4 to 6 and as described above, the set of cooling modules 22, 22′, 22″ comprises a main cooling module 22 and at least one secondary cooling module 22′, 22″.

The cooling modules 22, 22′, 22″ are juxtaposed in such a way as to have distinct airflows F passing through them. Having various juxtaposed cooling modules 22, 22′, 22″ means that it is possible to control the airflows F passing through each of the cooling modules 22, 22′, 22″ and thus control the heat-exchange surface areas required for the various aspects of thermal management.

In order to manage the passage of the airflows F through each cooling module 22, 22′, 22″, these modules may notably each comprise a dedicated shut-off device (not depicted). In the example illustrated in FIGS. 4 to 6, the set of cooling modules 22, 22′, 22″ more specifically comprises a main cooling module 22 and two secondary cooling modules 22′ and 22″. The secondary cooling modules 22′ and 22″ are in this instance positioned one on each side of the main cooling module 22 in the transverse direction Y.

These secondary cooling modules 22′, 22″ are structurally similar to the main cooling module 22. The secondary cooling modules 22′, 22″ also comprise at least one heat exchanger 28′, 28″ which is intended to be connected to a cooling circuit and a turbomachine 30′, 30″. That then makes it possible to control the heat-exchange surface area allocated to the thermal management of various elements, and thus adapt the cooling power to suit the demand, for example between normal use of the batteries and rapid charging thereof.

More specifically, the heat exchangers 28′, 28″ of the secondary cooling modules 22′ 22″ may also be condensers connected to the refrigerant circulation loop C configured for the thermal management of the batteries of the electric or hybrid vehicle.

According to a first embodiment, illustrated in FIG. 3, of the refrigerant circulation loop C, the heat exchangers 28, 28′, 28″ of the cooling modules 22, 22′, 22″ are connected in series within the refrigerant circulation loop C. The heat exchangers 28′ and 28″ of the secondary cooling modules 22′ and 22″ may notably be positioned downstream of the heat exchanger 28 of the main cooling module 22 within the refrigerant circulation loop C.

The refrigerant circulation loop C may also comprise a bypass branch (not depicted) making it possible to bypass the heat exchangers 28′ and 28″ of the secondary cooling modules 22′, 22″, so as to increase or reduce the surface area for exchange of heat between the airflow F and the refrigerant.

It is thus possible to increase or to reduce the surface area for exchange of heat between the airflow F and the refrigerant by controlling for example the airflow passing through the various cooling modules 22, 22′, 22″, notably the secondary cooling modules 22′, 22″ by means of the front face shut-off devices or else by controlling whether or not refrigerant circulates through the heat exchangers 28′ and 28″ of the secondary cooling modules 22′, 22″ by making use of the bypass branch.

According to a second embodiment, illustrated in FIG. 7, of the refrigerant circulation loop C, the heat exchangers 28, 28′, 28″ of the cooling modules 22, 22′, 22″ may be connected in parallel with one another within the refrigerant circulation loop C. That notably makes it possible to control which heat exchanger 28, 28′ 28″ will have the refrigerant pass through it, by controlling the refrigerant circulation loop C. It is thus possible to increase or reduce the surface area for heat exchange between the airflow F and the refrigerant by controlling the circulation of the refrigerant.

The secondary cooling modules 22′, 22″ may notably be smaller in size than the main cooling module 22. Specifically, the main cooling module 22 and its heat exchanger 28 remain the main heat-exchange surface and therefore the main source of cooling power while the secondary cooling modules 22′, 22″ and their heat exchangers 28′, 28″ are additional heat-exchange surfaces used in certain specific instances, for example during rapid charging of the batteries.

According to a first embodiment illustrated in FIG. 4, each cooling module 22, 22′, 22″ comprises an individual motor 31, 31′, 31″, configured to drive the rotation of the turbomachine 30, 30′, 30″ thereof. It is thus possible to generate an airflow F for each cooling module 22, 22′, 22″ independently, using their individual turbomachine 30, 30′, 30″.

According to a second embodiment illustrated in FIGS. 5 and 6, the set of cooling modules 22, 22′, 22″ may comprise a common motor 38 configured to drive the simultaneous rotation of the turbomachines 30, 30′, 30″ of each cooling module 22, 22′, 22″.

For that, the turbomachines 30, 30′, 30″ of the juxtaposed cooling modules 22, 22′, 22″ may be connected to one another by a connecting and driving shaft 32, as illustrated in FIG. 5. More specifically, one end of one turbomachine 30, 30′, 30″ is connected by means of a connecting and driving shaft 32 to one end of another turbomachine 30, 30′, 30″ that faces it.

As shown in FIG. 6, the connecting and driving shaft 32 may also comprise an articulation 33. This articulation 33 may for example be a cardan joint. This then makes it possible to modify the angle of the various cooling modules 22, 22′, 22″ relative to one another in order for example to conform to the rounded shape of the front face of the motor vehicle.

Thus it may clearly be seen that the front face of the motor vehicle, because of the set of juxtaposed cooling modules 22, 22′, 22″, allows the cooling power to be adapted according to the various levels of demand, thus making it possible to reduce the impact on the aerodynamic characteristics of the electric or hybrid vehicle.

1. A set of cooling modules for the front face of an electric or hybrid motor vehicle, wherein said set of cooling modules comprises at least two cooling modules each one comprising:
a heat exchanger intended configured to be connected to a cooling circuit; and
a turbomachine,
said cooling modules being juxtaposed in such a way as to have distinct airflows passing through them.

2. The set of cooling modules as claimed in claim 1, wherein the heat exchangers of the cooling modules are condensers connected to a refrigerant circulation loop configured for the thermal management of the batteries of the electric or hybrid vehicle.

3. The set of cooling modules as claimed in claim 2, wherein the heat exchangers of the cooling modules are connected in parallel with one another within the refrigerant circulation loop.

4. The set of cooling modules as claimed in claim 2, wherein the heat exchangers of the cooling modules are connected in series within the refrigerant circulation loop.

5. The set of cooling modules as claimed in claim 1, wherein each cooling module comprises an individual motor, configured to drive the rotation of the turbomachine thereof.

6. The set of cooling modules as claimed in claim 1, further comprising: a common motor configured to drive the simultaneous rotation of the turbomachines of each cooling module.

7. The set of cooling modules as claimed in claim 6, wherein the turbomachines of the juxtaposed cooling modules are connected to one another by a connecting and driving shaft.

8. The set of cooling modules as claimed in claim 1, where the cooling modules each comprise a dedicated shut-off device.

9. The set of cooling modules as claimed in claim 1, further comprising a main cooling module and at least one secondary cooling module smaller in size than the main cooling module.

10. A front face of an electric and/or hybrid motor vehicle comprising a set of cooling modules as claimed in claim 1.
